(19) United States
(12) Patent Application Publication
(10) Pub. No.: US 2009/0003566 A1
(43) Pub. Date: Jan. 1, 2009

(54) SYSTEM AND METHOD FOR SCORING RECORDED INTERACTIONS

(76) Inventor: Rachel Wentink, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/770,885

(22) Filed: Jun. 29, 2007

(51) Int. Cl. H04M 11/00; G06Q 10/00

(52) U.S. Cl. 379/112.01; 705/1

(57) ABSTRACT

A computer-implemented system and method for distributing recorded communications within a contact center for scoring based upon a set of positive and/or negative skills and attributes associated with each member of a set of scoring users and determined from each recorded communication. The central server maintains collection of recorded communications and a listing of scoring users and their associated criteria. Additionally, the system and method increases efficiency by distributing recordings to scoring users for scoring during times of low utilization or during previously scheduled scoring time blocks. When a scoring user is assigned a recording, the central server distributes the recording to the user in either a file format or through another communication device, such as a telephone, headset, or computer terminal. In addition, the central server automatically generates scoring progress and workload reports for easy assessment of progress, quality control, and workforce adjustment.

### FIELD OF THE INVENTION

The present invention generally relates to telecommunication systems and methods, as well as systems for operating contact centers. More particularly, the present invention pertains to a system and method for automatically facilitating the process of assigning and delivering recorded communications to supervisors for scoring within a contact center.

### BACKGROUND

A number of businesses and other organizations provide contact centers in which a plurality of personnel answer calls, such as telephone calls or other inquiries, e.g. from potential or existing customers. Contact centers serve a number of functions including facilitating the placement of orders for goods or services, providing information about products or the status of orders, receiving customer complaints or suggestions, dispensing product or technical information to assist customers in selecting or using products or services and the like.

Many such contact centers are configured so that the telephone or other communications facilities manned by the contact center personnel are coupled via a computer controlled system, e.g. for routing calls to available agents or other personnel. In the past, some such systems have included devices for facilitating supervision and/or monitoring the performance of such agents. For example, some devices are configured to collect, store, and/or analyze statistical data, while others store actual call recordings to be later analyzed and/or scored by contact center supervisors.

While previous systems of this type for facilitating supervision of contact center agents may have been adequate in many situations, they often require additional personnel and distract contact center employees from their primary task of speaking with customers. Previous systems are also inefficient at distributing recorded agent communications to appropriate knowledgeable contact center supervisors to ensure the highest level of scoring. For instance, a supervisor skilled in sales may be totally unqualified to score a dispute resolution communication. Additionally, communication recording may be routed to supervisors or experienced agents during downtime in order to increase productivity and efficiency. Therefore, there is a need for further improvement in the current ways in which agent communication scoring workload is distributed and handled

### SUMMARY

Various technologies and techniques are disclosed for intelligently distributing communication recordings amongst a group of scoring users in a contact center. A contact center server records a communication, such as an incoming call, and designates it for subsequent scoring. The system then matches the attributes of the recording to those of a subset of scoring users increasing the accuracy of scoring by assigning recordings to users having the requisite skills to analyze the communication. The system receives the scores assigned to each communication by the assigned users and processes them for use by a contact center manager.

In one embodiment, the system distributes recordings to the selected scoring users based upon availability or work load. In a further form, each scoring user is automatically scheduled for time blocks in which to receive and perform recording scoring.

In a further embodiment, the attributes of a communication recording are determined using IVR response, DNIS, caller ID, key press logging, and voice recognition.

In another form, the criteria associated with each scoring user may include skills possessed or lacked, such as languages spoken, sales abilities, customer service abilities, or specific product knowledge. Other criteria may include negative indications, such as the inability to score a particular type of recording, such as a recording having a particular agent due to a known bad working relationship.

Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one implementation.

FIG. 2 is a high-level process flow diagram demonstrating the stages involved in recording and distributing communications for scoring using the system of FIG. 1.

FIG. 3 is a representative screen shot of a communication scoring template suitable for use in one embodiment of the present system and method.

FIG. 4 is a design view of a sample user profile suitable for use in one embodiment of the present system and method.

FIG. 5 is a detailed flow chart illustrating the steps for distributing a recording communication for scoring in one embodiment of the present system and method.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

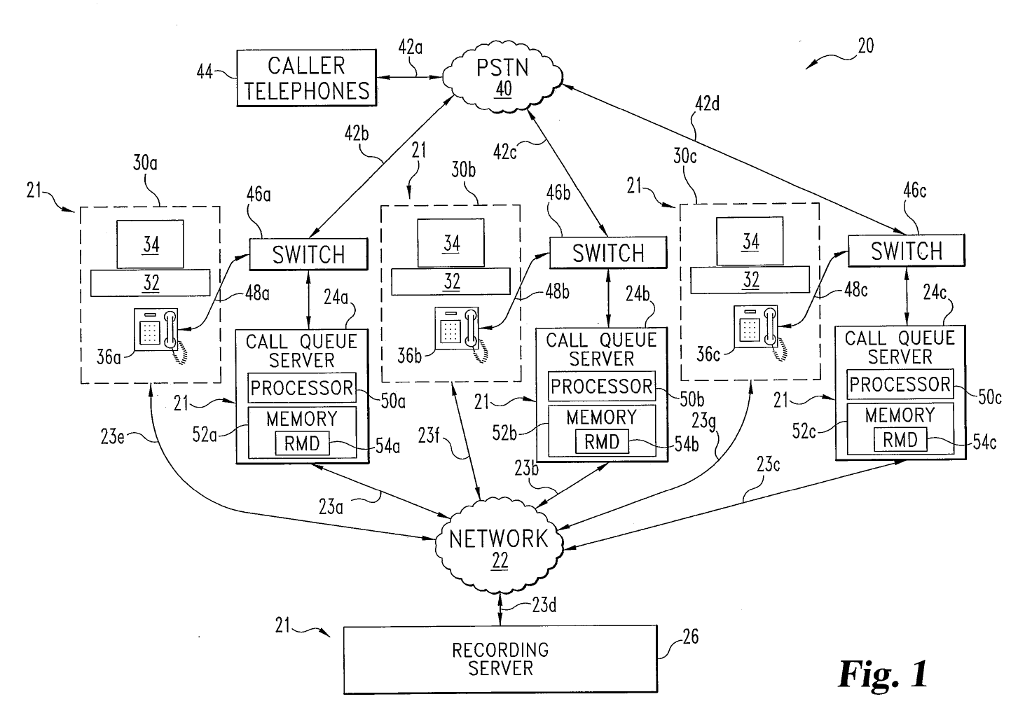

One implementation includes a unique system for distributing communication recordings for scoring within a contact center. FIG. 1 is a diagrammatic view of computer system 20 of one embodiment of the present invention. Computer system 20 includes computer network 22. Computer network 22 couples together a number of computers 21 over network pathways 23. More specifically, system 20 includes several servers, namely Call Queue Servers 24a, 24b, and 24c, and a Recording Server 26. System 20 also includes agent client workstations 30a, 30b, and 30c. While computers 21 are each illustrated as being a server or client, it should be understood that any of computers 21 may be arranged to include both a client and server. Furthermore, it should be understood that while seven computers 21 are illustrated, more or fewer may be utilized in alternative embodiments.

Call Queue Servers 24a, 24b, and 24c and Recording Server 26 include one or more processors or CPUs (50a, 50b, 50c, and 50d, respectively) and one or more types of memory (52a, 52b, 52c, and 52d, respectively). Each memory 52a, 52b, 52c, and 52d includes a removable memory device (54a, 54b, 54c, and 54d, respectively). Although not shown to preserve clarity, each computer 21 of system 20 includes one or more processors or CPUs and one or more types of memory. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or generic) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

System 20 further illustrates Public Switched Telephone Network (PSTN) 40 coupled to computer-controlled telephone switches 46a, 46b, and 46c (alternatively designated switches 46) of servers 24a, 24b, and 24c by pathways 42b, 42c, and 42d, respectively. Caller telephones 44 are coupled to PSTN 40 by pathway 42a. Switches 46 are also coupled to telephones 36a, 36b, and 36c (alternatively designated telephones 36) by lines 48a, 48b, and 48c. For the sake of clarity, each switch 46 is shown coupled to a single corresponding telephone 36. However, is should be understood that each of telephones 36 may be coupled to one or more switches and that switches 48 may be located at one or more physical locations and connected to a number of phones. Switches 46 may be arranged in the form of a Private Branch Exchange (PBX), predictive dialer, Automatic Call Distributor (ACD), a combination of these, or another switching configuration as would occur to those skilled in the art. Telephones 36 may be in the form of a handset, headset, or other arrangement as would occur to those skilled in the art. Telephones 36a, 36b, and 36c are each associated with a different one of agent workstations 30a, 30b, and 30c, respectively (collectively designated agent workstations 30). Agent workstations 30 each include an agent computer 32 coupled to a display 34. Agent computers 32 may be of the same type, or a heterogeneous combination of different computing devices. Likewise, displays 34 may be of the same type, or a heterogeneous combination of different visual devices. Although not shown to preserve clarity, each agent workstation 30 may also include one or more operator input devices such as a keyboard, mouse, track ball, light pen, and/or microtelecommunicator, to name just a few representative examples. Also, besides display 34, one or more other output devices may be included such as loudspeaker(s) and/or a printer.

Computer network 22 can be in the form of a Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22. It should also be recognized that computer network 22 may include one or more elements of PSTN 40. Indeed, in an alternate embodiment, PSTN 40 and computer network 22 are provided as a common network.

In one embodiment, system 20 operates as a contact center at one or more physical locations that are remote from one another with call queue servers 24a, 24b, and 24c being configured as contact center server hosts, Recording Server 26 being configured as a server for storing a large number of communication recordings and associated scoring information, and agent workstations 30a, 30b, and 30c each arranged as a contact center client host. In an alternate form, system 20 may include one or more Recording Servers 26, such as one per geographic location or one per call queue server 24 as may be required to handle communication recording load. It shall be understood that each agent workstation (collectively 30) may have varying degrees of permissions, such as in the instance of a supervisor being logged in. Additional telephones 36 may be connected to switches 46 that each correspond to an additional client host to provide more agent workstations 30 (not shown). Typically contact center applications of system 20 would include many more agent workstations of this type at one or more physical locations, but only a few have been illustrated in FIG. 1 to preserve clarity. Also, one or more servers 24 may be configured as a contact center server host at one or more physical locations. Furthermore, one or more servers 24 may also be configured to provide, collectively or individually, the features of Recording Server 26 described herein. In a further form, a database server, storage area network, or other storage type known to one of skill in the art may be connected to Recording Server 26 to facilitate storage of communication recordings and associated information.

Alternatively or additionally, system 20 may be arranged to provide for distribution, routing, recording, and scoring of a number of different forms of communications, such as telephone calls, voice mails, faxes, e-mail, web chats, web call backs, and the like. In addition, while the illustrative embodiment utilizes the PSTN, alternative embodiments may implements other forms of communications such as VoIP or other digital communication. Furthermore, business/customer data associated with various communications may be selectively accessed with system 20. This data may be presented to an agent at each agent workstation 30 by way of monitor 34 operatively coupled to the corresponding agent computer 32.

References herein to a communication shall include, but not be limited to, telephone calls, voicemails, e-mail, instant messaging, chats, video conferences, and/or any other communication type known to one of skill in the art. References to a communication recording shall be understood to include, by way of non-limiting example, a digital or analog recording or transcript of a communication, any meta-data, screen captures, and/or signaling information associated with the communication. Further, references to a telephone call in the illustrative embodiment shall be understood to include traditional PSTN calls and digital telephony such as VOIP, SIP, and SRTP to name just a few. Furthermore, references herein to a score shall be understood to include, by way of non-limiting example, one or more numerical values, one or more letter grades, or a completed evaluation form. The present system and method may be applied to many other types of communications and their use within the current system and method is desired to be protected.

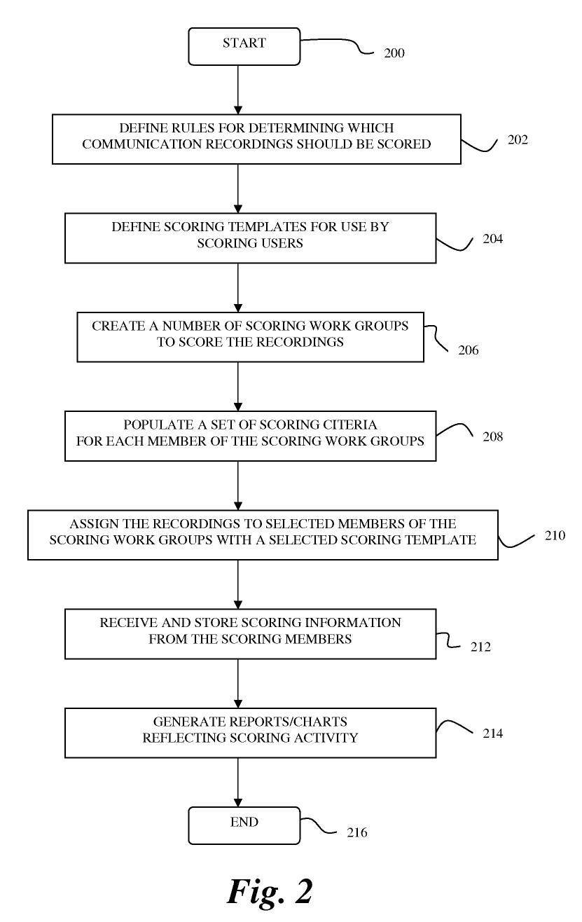

Turning now to FIG. 2 with continued reference to FIG. 1, the stages for implementing one or more aspects of system 20 are described in further detail. FIG. 2 is a high level process flow diagram that demonstrates the process for configuring and operating system 20 to automatically distribute selected communication recordings to a workgroup of scoring users, receive and store the scores assigned by the scoring users, and generate reports based upon scoring progress, status, and workload in addition to agent performance. In one form, the process of FIG. 2 is at least partially implemented in the operating logic of system 20.

The process begins at start point 200 with the system 20 receiving a set of business rules defining which communication recordings should be scored (stage 202). In the illustrative embodiment, these business rules are utilized by Recording Server 26 to select a subset of communication recordings from a continually growing/changing collection it maintains. In one form, the business rules are defined in Recording Server 26 using an agent workstation, such as workstation 30a, having the requisite permission, such as those granted to a contact center manager upon login. In a further form, the rules are defined using a software implemented wizard allowing a contact center manager or other supervisor to quickly define what portion and/or type of recordings should be scored and other associated attributes. It shall be appreciated that any method of selectively recording communications within a contact center, such as by Recording Server 26, and any method of selecting previously recorded communications for scoring will meet the needs of the present system and method.

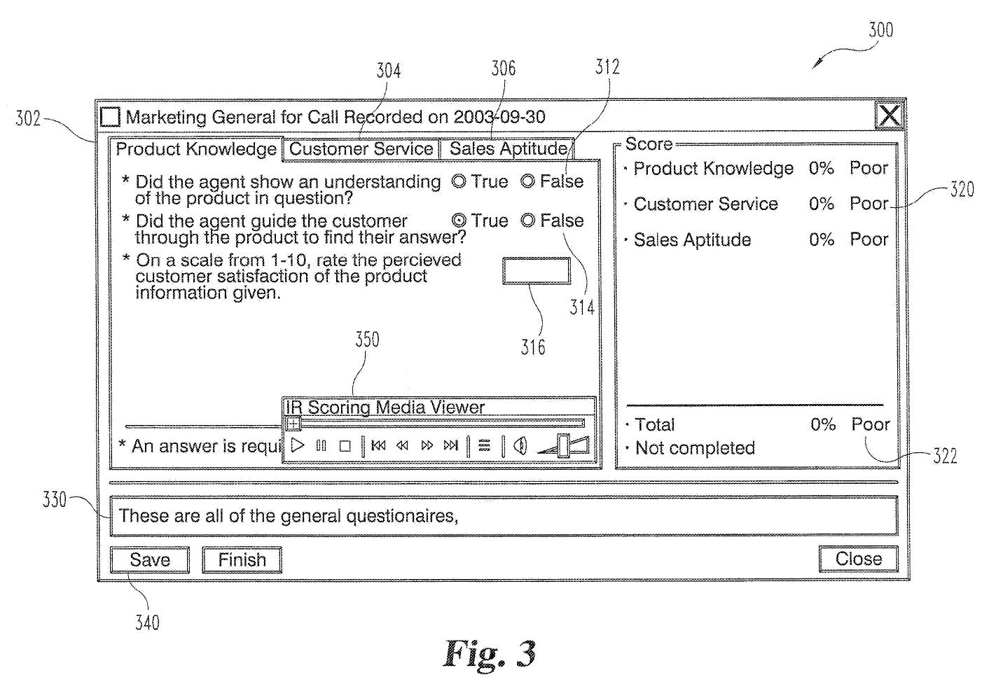

In addition to selecting a subset of communication recordings for scoring (stage 202), a set of scoring templates are selected/created (stage 204). In the illustrated embodiment, as illustrated in FIG. 3, scoring form 300 is an electronic form to be completed by a scoring user which is generated using a predefined scoring template. In one form, the scoring form 300 is generated by Recording Server 26 for scoring of an identified recording using characteristics of the recording, such as its communication type, subject matter, or length, and presented to the scoring user at a workstation, such as workstation 30, using network 22 and monitor 34. Preferably, the communication recording to be scored is presented to the scoring user simultaneously with the scoring form 300. In one form, the communication recording is sent to the computer of the scoring user for playback, such as in the form of an audio file, while in others forms it may be played back to the scoring user through an associated telephone or other communication device.

Scoring form 300 is divided into several components, such as Product Knowledge tab 302, Customer Service tab 304, and Sales Aptitude tab 306. It shall be understood than any combination of tabs, such as those illustrated or otherwise, could be combined. Starting with tab 302, the scoring user may interface with the scoring form 300 to assign scores to various criteria such as, by way of non-limiting example, the agent's understanding of the product, the agent's customer interaction skills, and/or the agent's overall performance using scoring methods such as true/false radio buttons 312, slider bar 314, or empty field 316. The types of scoring information collected by other tabs, such as tab 304 and 306 may be determined by the contact center manager during stage 202. In the illustrative embodiment, Customer Service tab 304 collects information regarding the agent's ability to provide the customer with what they need in a prompt and courteous manner, while Sales Aptitude tab 306 allows for a scoring user to evaluate the ability of an agent to make a sale and otherwise promote products or services offered.

Once the scoring user completes scoring form 300, including a number of tabs, the scoring user may see summary results of their scoring in overview window 320 as well as the currently updated scoring results from all scoring users or average scores of a particular communication or associated agent in overall results window 322. Additionally, any comments may be entered into comments field 330 which the scoring user may desire. In an alternate form, instructions may also be inserted into the comments field 330 by Recording Server 26 for use by a scoring user. Once the scoring form 300 is completed, the scoring user selects the save option 340 and the scoring information is transmitted to Recording Server 26 using network 22. Additionally, the scoring user is able to listen to the recorded communication using integrated playback controls 350.

It shall be appreciated that a number of scoring templates are created for use by system 20, and may include a series of customized templates for varying forms of communications, differing subject matter, or communications of different length, as may be required by varying implementations. In a still further form, the scoring templates may be dynamically generated for each individual communication recording based upon attributes derived from the communication or the parties to the communication. In one form, in the case of multiple users scoring the same communication recording, each scoring user completes a similar scoring template. In an alternate form, different scoring users complete differing scoring templates for a single recording based upon their skills and/or areas of the recording identified as needing more input. For example, if a recording received comparable scores for product knowledge, the Recording Server 26 may be satisfied that the scores are accurate, but in the event the Recording Server 26 receives a diverse range of scores for sales aptitude, the recording may be assigned to additional users for scoring in an attempt to harmonize the score assigned to that aspect. In other forms, the scoring templates may additionally be made available in a web page allowing platform independence and/or remote completion.

In order to complete the forms, at least one workgroup of scoring users is created (stage 206) The workgroup includes a number of selected users having sufficient skill and experience to provide accurate scores to communication recordings. In one form, the system may have a plurality of different workgroups, with each workgroup representing a set of scoring users having a similar area of expertise, experience level, or scheduled availability time. Users assigned to a scoring workgroup may be supervisors, experienced agents, or any other contact center personnel. It shall be appreciated that the system configuration steps defined above may occur concurrently or in any order.

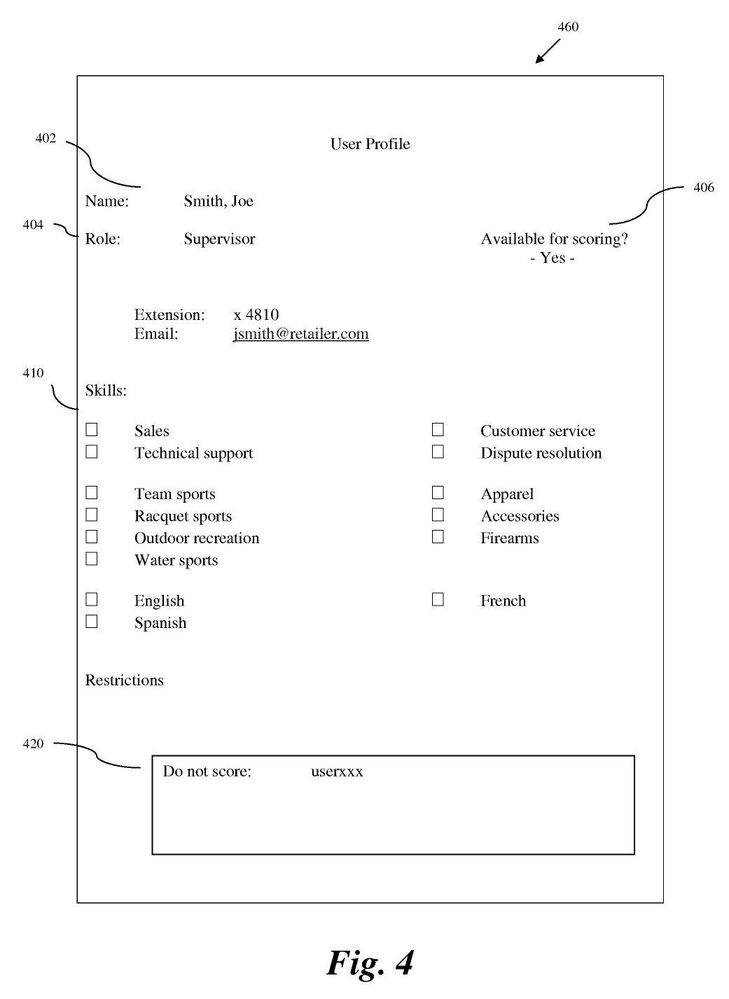

Once the workgroups of scoring users have been defined (stage 206), a listing of information and criteria for each individual member of the workgroups is populated (stage 208). In the illustrative embodiment, as illustrated in FIG. 4, a user profile 400 includes a listing of criteria having both positive and negative aspects for use in communication recording distribution. User profile 400 includes a user name field 402, a user role field 404 indicating the user's access level, such as an agent, supervisor, or manager, and user availability flag 406 indicating whether or not the user is currently available to perform scoring. In an alternate form, flag 406 may be replaced by the user's current or forecast workload or the schedule of the user, either showing time scheduled for work or time scheduled specifically for scoring.

User profile 400 includes a set of criteria 410 which is used by Recording Server 26 in distributing communication recordings for scoring. The criteria 410 include a customized listing of skills useful to a contact center operation. For instance, in a contact center primarily involved in technical support communications, whether or not a user has a skill, such as knowledge of a particular individual product types, is very valuable in routing a communication recording involving that product for scoring. Similarly, in a contact center of an online retailer, whether or not a user has a skill in handling disputes may be an important skill for identifying a proper scoring user or users.

In one form, each skill is either indicated as possessed or not by the user's associated user profile 400. In a further form, each skill may be indicated as possessed, not possessed, or particularly not suited for, thereby allowing skills to be indicated as particularly problematic for certain users. In a still further form, each skill may have a score indicating the level of the skill possessed, either positive or negative. By way of non-limiting example, the skills may include numerous areas of expertise, such as sales, tech support, dispute resolution, customer support, languages spoken, or the like. In addition, the criteria 410 may also include negative indications, such as a particular lack of skill in an area, or the profile 400 may include restrictions, such as restriction 420, or other reasons that may impact the ability of a user to accurately score a communication recording, such as a bad working relationship with a contact center agent which may lead to inaccurate or biased scoring.

In one form, the scoring criteria 410 of user profile 400 are populated initially by a supervisor and updated periodically. In another form, the scoring criteria 410 are updated automatically by the system 20 based upon the number of communications the user has handled or the user's own scored communication or reviewed scores. Preferably, a user interface allows for easy selection of skills, indications, and other aspects of the scoring criteria for each user.

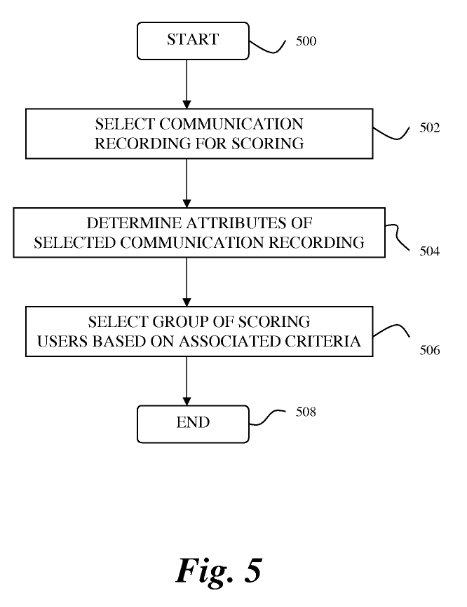

Once the scoring users are known to Recording Server 26, a selected communication recording may be assigned to one or more scoring users (stage 210) using the criteria associated with each scoring user and a set of information obtained by system 20 relevant to the communication recording. Turning to FIG. 5, a detailed flow chart of the process for assigning a communication recording to a group of scoring users is illustrated. Turning to FIG. 5, a detailed flow chart of the process for assigning a communication recording to a group of scoring users is illustrated. The process begins at start point 500 with Recording Server 26 selecting a communication recording for scoring (stage 502). Once the recording is selected, using a set of rules defined in step 202, from a collection of recordings stored by Recording Server 26, the process proceeds to determine the attributes of the selected communication recording (stage 504). The attributes of a communication recording may include the agent(s) participating in the communication, the type of communication, i.e. telephone call, web chat, etc., the subject matter of the communication, the duration of the communication, the language in which the communication takes place, and many others. In the illustrative embodiment, the Recording Server 26 utilizes DNIS, Caller ID, IVR responses, key presses, voice recognition, and other methods to determine the attributes of a communication. It shall be appreciated that these attributes may be determined at the time of recording and archived or may be determined at a later time, such as the time of assignment for scoring.

Once the Recording Server 26 has the attributes of a communication recording, the Recording Server 26 attempts to find a scoring user having the best available associated criteria for the particular recording (stage 506). In the illustrative embodiment, a simple matching algorithm is utilized, with certain aspects of the recording being required and other preferred for a scoring user. Other methods of matching, such as vector distance, or weighted average may be utilized. In addition, negative criteria, such as a bad working relationship indication or a lack of skill in a specific area of expertise may block a particular user from being assigned to score a particular communication. Additionally, the availability of a scoring user may impact which user is selected. For instance, if a recording requires immediate scoring then a user who is currently available for scoring or who has a light work load must be selected whereas a less urgent recording may be assigned to a user who will not be available to score it for several days or more. The process ends at end point 508.

Once the scoring users are selected for a recording (stage 210), the distribution of communication recordings and their proper scoring template may begin (stage 212). In the illustrative embodiment communication recordings are distributed to scoring users when available. In one form, communication recordings may be inserted into a work queue of a scoring user just like other work tasks, such as training sessions or other incoming/outgoing communications. In another form, a user may select an “Available for Scoring” state and automatically begin to receive queued communications from Recording Server 26 for scoring. In a further form, a scoring user may be automatically entered into the “Available for Scoring” state in response to a scheduled time which may be an entire work shift or merely a portion thereof.

Once a recording has been assigned to a scoring user (stage 212), the Call Queue Servers 24 await and receive scoring information assigned to each communication recording for processing and storage (stage 214). In the illustrated embodiment, a communication recording is assigned to multiple scoring users and the scores are combined to create a final score for each recorded communication. Optionally, upon receipt of a number of scores for a communication recording, the recording may be archived or deleted as desired by Recording Server 26. Preferably, the Recording Server 26 actively monitors the scoring of assigned communication recordings and provides status reports, reminders, and feedback to scoring users. The process ends at endpoint 216.

At any time throughout the ongoing process, a user or contact center supervisor may request the status of communication recording workload and progress. In response, Recording Server 26 determines the status of each recorded communication, which, in the illustrative embodiment may be unassigned, awaiting scores, or completed. The reports may be customized to provide any information stored by Recording Server 26 or determinable therefrom. In the illustrative embodiment, the reports generated may be especially useful in determining the number of scoring users required in order to efficiently score selected recordings as well as to monitor the progress of scoring users through their assigned recordings for scoring.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed is:

1. A method comprising the steps of:
recording a set of communications, each having a first party, in a contact center to create a recording set;
selecting a subset of recordings from said recording set to be scored;
designating a plurality of users within said contact center to score said subset of recordings;
populating a first set of criteria indicating associated skills for each of said plurality of users;
identifying a second set of criteria for each recording in said subset of recordings; and
assigning each recording to at least one user within said plurality of users to be scored based on said first set of criteria and said second set of criteria without manual intervention.

2. The method of claim 1, wherein said subset of recordings is selected using a set of predefined business rules.

3. The method of claim 2, wherein said set of predefined business rules are defined by a contact center manager.

4. The method of claim 1, wherein said set of communications are voice calls.

5. The method of claim 1, wherein said set of communications are web chats.

6. The method of claim 1, wherein said set of communications are e-mails.

7. A method of claim 1, wherein said first party is at a remote location from said contact center.

8. The method of claim 7, wherein said first party initiates said set of communications.

9. The method of claim 7, wherein said contact center initiates said set of communications.

10. The method of claim 1, wherein said plurality of users are contact center supervisors.

11. The method of claim 1, wherein said first set of criteria includes an indicator of at least one type of communication a user should not be allowed to score.

12. The method of claim 11, wherein said indicator prevents a user from scoring recordings involving a particular user.

13. The method of claim 1, wherein said first set of criteria includes associated skills selected from the group consisting of languages spoken by the user, subject matter expertise, and experience level.

14. The method of claim 1, wherein said second set of criteria includes information identifying the nature of the communication associated with the recording.

15. The method of claim 14, wherein said second set of criteria includes IVR responses.

16. The method of claim 14, wherein said second set of criteria includes keywords selected from a transcript of the recording.

17. A method of claim 1, further comprising the step of:
associating a scoring template with said first recording based on said second set of criteria.

18. The method of claim 17, wherein said scoring template is selected using said predefined business rules.

19. The method of claim 17, wherein said scoring template is an electronic form.

20. The method of claim 19, wherein said scoring template is an HTML web page.

21. The method of claim 17, wherein said form is electronically sent to an assigned user.

22. The method of claim 1 wherein said contact center is comprised of multiple facilities at several geographically distinct locations.

23. A method comprising the steps of:
maintaining a listing of users authorized to score communication recordings using an ACD within a contact center;
queuing a set of communication recordings in need of scoring;
activating a first scoring user within said listing;
sending a request for scoring to said first scoring user using said ACD; and
providing a first communication recording from said set of communication recordings in response to an indication of acceptance received from said first scoring user.

24. The method of claim 23, wherein said activating occurs in response to a scheduled time.

25. The method of claim 23, wherein said activating occurs in response to an indication of a willingness to score communications received from said first scoring user.

26. The method of claim 23, wherein said set of communication recordings are voice call recordings.

27. The method of claim 26, wherein said providing includes playing said communication recording to said first scoring user through a telephone.

28. The method of claim 26, wherein said providing includes sending said communication recording to a computer associated with said first scoring user in an audio file.

29. The method of claim 26, wherein said providing includes streaming said communication recording to a computer associated with said first scoring user.

30. The method of claim 23, further comprising the step of:
transmitting a work assignment in response to an indication that said first communication recording has been scored.

31. The method of claim 30, wherein said work assignment is an incoming communication.

32. The method of claim 23, wherein said first communication recording is selected from said set of communication recordings based upon a set of skills associated with said scoring user.

33. A system comprising:
a first contact center server including a communication queue; and
a recording server coupled to said contact center server over a network, the recording server receiving a communication status update from said contact center server regarding at least a first agent and sending a communication recording to a workstation associated with said first agent in response to said call status update indicating that the number of calls stored in said communication queue serviceable by said first agent is below a predetermined threshold.

34. The system of claim 33, wherein said predetermined threshold is one communication.

35. The system of claim 33, wherein said communication queue maintains a listing of telephone calls.
